(19) United States
(12) Patent Application Publication
(10) Pub. No.: US 2002/0062289 A1
(43) Pub. Date: May 23, 2002

(54) Method and system for completing a transaction about an access providing and fee-charging

(75) Inventor: Kenji Kondo, Tokyo (JP)

Correspondence Address: STEVEN I. WEISBURD, ESQ., DICKSTEIN SHAPIRO MORIN & OSHINSKY LLP, 1177 AVENUE OT THE AMERICAS - 41 ST FLOOR, NEW YORK, NY, 10036-2714, US

(73) Assignee: NEC Corporation

(21) Appl. No.: 09/995,995

(22) Filed: Nov. 16, 2001

(30) Foreign Application Priority Data
Nov. 17, 2000 (JP) 351078/2000

(51) Int. Cl. G06F 17/60

(52) U.S. Cl. 705/52

(57) ABSTRACT

A method for providing a variable communication quality network access for a user. The method is preferably implemented in software program. The system applying the method allows a user to request a communication quality. When receiving the request, the system starts to ensure the communication quality requested by the user, and provides the user with an access with the communication quality. When detecting an end of a communication with the communication quality, the system charges on the user an access fee based on the communication quality and a time interval between the starting and the end of the communication.

### BACKGROUND OF THE INVENTION:

1. Field of the Invention:

The present invention generally relates to a method and system that provides a user with an access to a network with a quality requested by the user while charging an access fee at a measured rate. For example, the network is the Internet, and the network access fee is the Internet access fee paid by a user to a network access provider, such as an ISP (Internet Service Provider) that contracts with the user. The term “ISP” hereinafter includes not only the one who only serves as an ISP but also the backbone provider who also serves as an ISP.

2. Description of the Related Art:

Most of the people contract with ISPs to access to the Internet, paying the ISPs the Internet access fees set by the ISPs. Known types of the Internet access fee charging system are “flat rate” and “measured rate,” and each user preselects any one of them at the time of the contract. At the contract time, users also select, from options provided by ISPs, ensured communication quality as to bandwidth, data delay and so on.

However, such contract systems have two major problems. One problem is that it becomes difficult for ISPs to make profits proportional to communication data amount, because many users recently preselect flat rate charging system. The other problem is that the user must be compliant with the contract even if the user occasionally requires wider bandwidth in order to play a real-time network game, to watch a TV program on the Internet, or the like.

As apparent from the above, a need exists for a method and system that permits a user to request, at the time of starting a communication, a communication quality for an ISP who contracts with the user.

### SUMMARY OF THE INVENTION:

The present invention therefore provides a system and method for providing a variable communication quality network access for a user. The method allows a user to request, at the time of starting a communication, a communication quality for a network access provider, such as an ISP.

A method according to one aspect of the present invention comprises: electronically receiving from the user an ensuring request about a communication quality; starting to ensure the communication quality requested by the user, so as to provide the user with an access with the communication quality; detecting an end of a communication with the communication quality; and charging on the user an access fee based on the communication quality and a time interval between the starting and the end of the communication.

The foregoing method can be implemented as a computer program within an ISP's host computer, and can be built as a system for electronically completing the above-mentioned transaction.

A more complete understanding of the present Invention, as well as further features and advantages of the present invention, will be obtained by reference to the following detailed description and drawings.

### BRIEF DESCRIPTION OF THE DRAWINGS:

FIG. 1 is a schematic view of a computer network in accordance with an embodiment of the present invention;

FIG. 2 is a schematic view of an access router illustrated in FIG. 1;

FIG. 3 is a schematic view of a fee-charging server illustrated in FIG. 1;

FIG. 4 is a schematic view of a computer network in accordance with another embodiment of the present Invention; and

FIG. 5 is a schematic view of a computer network in accordance with another embodiment of the present invention;

### DESCRIPTION OF A PREFERRED EMBODIMENT:

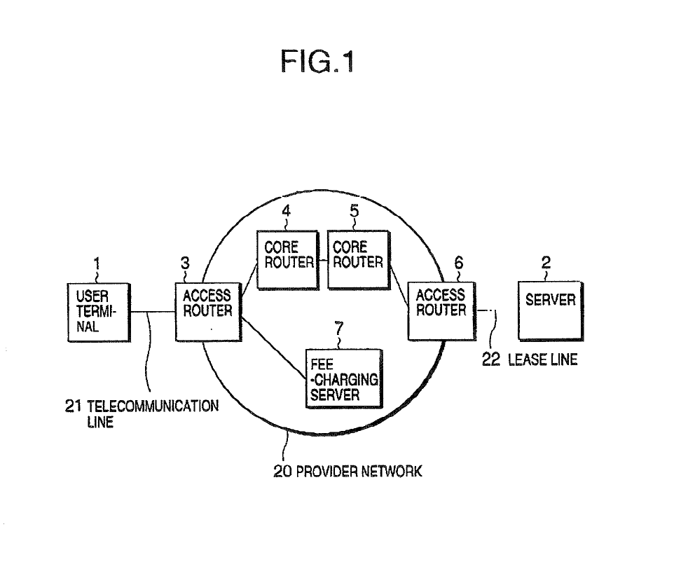

A method and apparatus of the present invention will now be discussed with reference to FIGS. 1 to 5. The present invention allows a user to request a communication quality for an ISP who contracts with the user.

With reference to FIG. 1, a computer network according to a first embodiment of the apparatus and method of the present invention is illustrated. As shown in FIG. 1, the computer network of the present embodiment generally comprises a user terminal 1, a server 2 and a provider network 20 that is owned by an ISP and that is connected to the user terminal and the server 2, for example, by a telecommunication line 21 and a lease line 22, respectively. The illustrated provider network 20 comprises access routers 3 and 6, core routers 4 and 5, and a fee-charging server 7. In actual, other types of servers may constitute the provider network but arc omitted in the figure for the sake of clarity.

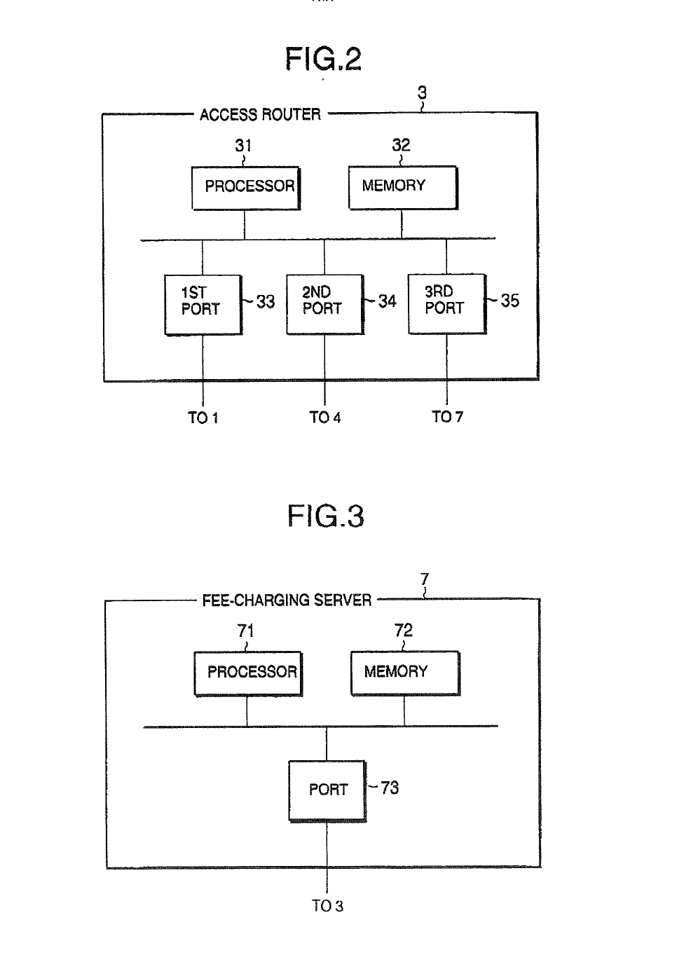

As shown in FIG. 2, the access router 3 comprises, for example, a processor 31, a memory 32, and first and third ports 33-35. The memory 32 may conceptually include a random access memory (RAM), a hard-disk drive (HDD), and so on The memory 32 contains a computer program which when executed by the processor 31 causes the processor 31 to perform a method according to the present embodiment, which is discussed in greater detail later. The first port 33 is used to cause the user terminal 1 to access to the access router 3, in cooperation with the computer program stored in the memory 32 and the processor 31 executing the computer program. More concretely, cooperating the computer program and the processor 31, the first port 33 provides PPP connection between the user terminal 1 and the access router 3 as the initial step of accessing to the provider network 20. The second port 34 is controlled by the processor 31 executing the computer program, so as to provide a communication path to the core router 4. Similarly, the third port 35 is controlled by the processor 31 executing the computer program, so as to provide a communication path to the fee-charging server 7. If both the access router 3 and the fee-charging server 7 are installed on one computer system, the third port is a “virtual” port.

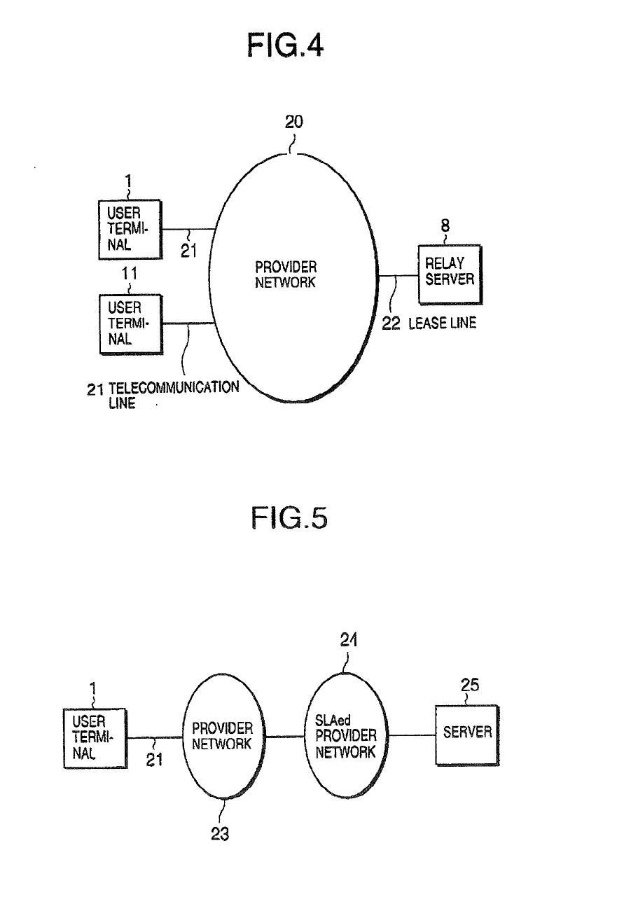

Referring to FIG. 4, the fee-charging server 7 will be described in greater detail. The fee-charging server 7 comprises, for example, a processor 71 that controls the operation of the fee-charging server 7. The processor 71 is electronically connected to a memory 72, a port 73. The memory 72 may conceptually Include a random access memory (RAM), a hard-disk drive (HDD), and so on. The memory 72 stores a computer program including software instructions which when executed by the processor 71 causes the processor 71 to carry out a fee-charging in accordance with the present embodiment. The port 73 provides the communication path to the third port 35 of the access router 3, in cooperation with the computer program and the processor 71.

The method according to the present embodiment will now be discussed in greater detail. In the followings, although the access router 3 and the fee-charging server 7 are performed by the processors 31 and 71 executing the computer program stored in the memory 32 and 71, respectively, descriptions are made about them as actions of the access router 3 and the fee-charging server 7, for the sake of clarity.

The user starts up a PPP connection program, and establishes the PPP connection between the user terminal 1 and the access router 3. Then the user sends for an access router 3 a designation of source node (i.e. server 2 in this embodiment) and an ensuring request about a communication quality that includes for example a communication data rate request.

The access router 3 receives the designation and the ensuring request from the user, and then carries out an ensuring the communication quality requested by the user For example, the ensuring the communication quality employs the known protocol such as RSVP (Resource Reservation Protocol) or the like, but may employ a specified protocol defined to ensure the communication quality. In addition, the provider network 20 applies to the ensuring the communication quality the known techniques, for example, IP (Internet Protocol) tunneling technique and MPLS (Multi Protocol Label Switch) technique. The techniques are carried out with packet-transfer techniques.

In detail, the access router 3 communicates with the core router 4, the core router 5, and the access router 6 that reside on the communication path between the access router 3 and the server 2 as the designated source node. The selection of the core router 4, the core router 5, and the access router 6 is carried out in accordance with the routing tables that are arranged and distributed in the provider network.

Then the access router 3 sends queries for the core router 4, the core router 5, and the access router 6, and asks whether it is possible to ensure the communication quality. The core router 4, the core router 5, and the access router 6 judge whether the routers themselves can meet the communication quality on the basis of their network resources, and reply to the queries by sending reply messages for the access router 3.

In response to the reply messages, the access router 3 judges whether it is possible to ensure the communication quality. If impossible, the access router 3 notifies the user that it is impossible to ensure The communication quality. If possible, the access router 3 starts to ensure the communication quality requested by the user, so as to provide the user with an access with the communication quality. At the same time, the access router reports for the fee-charging server 7 a start of a communication and the communication quality.

When receiving the start of the communication and the communication quality from the access router 3, the fee-charging server 7 holds them and starts charging on the user an access fee based on the communication quality.

When detecting an end of the communication with the communication quality, the access router 3 reports for the fee-charging server 7 the end of the communication.

When receiving the end of the communication from the access router 3, the fee-charging server 7 finishes to charge on the user the access fee based on the communication quality and a time interval between the start and the end of the communication. Thus the above-mentioned fee-charging system employs “measured rate,” for example, a minutely fee rate In addition, the fee-charging system calculates the access fee in consideration of the communication quality requested by the user. Therefore the system is reasonable for both the user and the provider.

With reference to FIG. 4, another computer network according to a second embodiment of the apparatus and method of the present Invention Is Illustrated. The illustrated computer network comprises user terminals 1 and 11, a provider network 20 and a relay server 8. The illustrated provider network 20 comprises access routers, core routers, and a fee-charging server, as the similar way of the above-mentioned first embodiment, but the access routers, the core routers, and the fee-charging server are not shown in the figure for the sake of simplification.

In the illustrated embodiment, two users using the user terminals 1 and 11 make a communication with each other through The provider network 20 and the relay server 8, where both the user terminals 1 and 11 have IP addresses dynamically assigned by the provider. The dynamic assignment of IP address may be achieved by the known techniques, for example, DHCP (Dynamic Host Configuration Protocol) and so on. In the initial stage, since the user terminals 1 and 11 can not know connection partner's IP addresses, the communication must use The relay server 8. However, In the next stage, the user terminals 1 and 11 may directly communicate with each other not thorough the relay server, if the user terminals 1 and 11 knew connection partner's IP addresses after the initial stage.

With reference to FIG. 5, another computer network according to a second embodiment of the apparatus and method of the present invention is illustrated. The illustrated computer network comprises a user terminal 1, a provider network 23, another provider network with SLA 24 (referred to as an SLAed Provider Network in the figure), and a server 25. The server 25 has the same function as the server 20 of the first embodiment. The provider network 23 comprises access routers, core routers, and a fee-charging server, as the similar way of the provider network 20 of the above-mentioned first embodiment, but the access routers, the core routers, and the fee-charging server are not shown in the figure for the sake of simplification. The SLAed provider network 24 also comprises access routers, core routers, and a foe-charging server, as the similar way of the provider network 20 of the above-mentioned first embodiment, but the access routers, the core routers, and the fee-charging server are not shown in the figure for the sake of simplification. The provider providing the provider network 23 and another provider providing the SLAed provider network 24 conclude an SLA (Service Level Agreement) with each other.

A general description of the present invention as well as a preferred embodiment of the present invention has been set forth above. Those skilled in the art to which the present invention pertains will recognize and be able to practice additional variations in the methods and system described which fall within the teachings of this Invention For example, although the line connecting between the user terminal and the access router is a telecommunication line in the preferred embodiment of the present invention, the connection line may be another type of line, for example, a cable for CATV or the like. In addition, although the server designated by the user is not included in the provider network and the lease line connects between the server and the provider network, the server may be included in the provider network, for example, In the case where the provider provides “hosting service” and the server is implemented in the provider network by the use of the hosting service. All such modifications and additions are deemed to be within the scope of the invention which is to be limited only by the claims appended hereto.

This application is based on Japanese Patent Application filed on Nov. 17, 2000, No. 2000-351078, and those claims, specification and drawings are incorporated herein by reference.

What is claimed is:

1. A method for providing a variable communication quality network access for a user, comprising:
electronically receiving from the user an ensuring request about a communication quality;
starting to ensure the communication quality requested by the user, so as to provide the user with an access with the communication quality;
detecting an end of a communication with the communication quality; and
charging on the user an access fee based on the communication quality and a time interval between the starting and the end of the communication.

2. A method as claimed in claim 1, wherein the ensuring request about the communication quality comprises a communication data rate request.

3. A method as claimed in claim 2, further comprising, after the electronically receiving the ensuring request and before the starting to ensure the communication quality;
judging whether it is possible to ensure the communication quality in consideration of various network resources; and
if impossible, electronically notifying the user that it is impossible to ensure the communication quality.

4. A variable communication quality network access provider implementing a method as claimed in claim 1, the provider comprising:
a core router;
an access router connected to the core router and connectable by a user, comprising a first processor and a first memory device storing a first program which, when executed by the first processor, causes the first processor to perform a first predetermined operation;
a fee-charging server connected to the access router, comprising a second processor and a second memory device storing a second program which, when executed by the second processor, causes the second processor to perform a second predetermined operation; wherein:
the first predetermined operation comprises:
electronically receiving from the user an ensuring request about a communication quality;
judging whether it is possible to ensure the communication quality, by communicating with the core router;
if possible, starting to ensure the communication quality requested by the user, so as to provide the user with an access with the communication quality and to report for the fee-charging server a start of a communication and the communication quality; and
detecting an end of the communication with the communication quality to report for the fee-charging server the end of the communication; and
the second predetermined operation comprises:
electronically receiving the start of the communication and the communication quality from the access router;
electronically receiving the end of the communication from the access router; and
charging on the user an access fee based on the communication quality and a time interval between the start and the end of the communication.

5. A variable communication quality network access provider as claimed in claim 4, wherein the first predetermined operation further comprises, where the judging result is impossible, electronically notifying the user that it is impossible to ensure the communication quality.

6. A variable communication quality network access provider as claimed in claim 4, wherein the ensuring request about the communication quality comprises a communication data rate request.

7. An access router used in a variable communication quality network access provider implementing a method as claimed in claim 1, the access router comprising;
a first port connectable by the user;
a second port connected to a core router;
a third port connected to a fee charging server for charging on the user a access fee;
a memory device storing a program;
a processor in communication with the memory;
the processor operative with the program to:
electronically receive from the user an ensuring request about a communication quality;
judge whether it is possible to ensure the communication quality, by communicating with the core router;
if possible, start to ensure tho communication quality requested by the user, 30 as to provide the user with an access with the communication quality and to report for the fee-charging server a start of a communication and the communication quality;
detect an end of the communication with the communication quality; and
report for the fee-charging server the end of the communication to cause the fee-charging server to charge on the user an access fee based on the communication quality and a time interval between the start and the end of the communication.

8. An access router as claimed in claim 7, wherein the processor Is further operative to, In a case where the judging result Is impossible, electronically notify the user that it is impossible to ensure the communication quality.

9. An access router as claimed in claim 7, wherein the ensuring request about the communication quality comprises a communication data rate request.

10. A computer program which is for an access router for providing a user with a variable communication quality network access, and which when executed by a processor of the access router causes the processor to perform:
electronically receive from the user an ensuring request about a communication quality;
judge whether it is possible to ensure the communication quality, by communicating with a core router connected to the access router;
if possible, start to ensure the communication quality requested by the user, so as to provide the user with an access with the communication quality and to report, for a fee-charging server connected to the access router, a start of a communication and the communication quality;
detect an end of the communication with the communication quality; and
report for the fee-charging server the end of the communication to cause the fee-charging server to charge on the user an access fee based on the communication quality and a time interval between the start and the end of the communication.

11. A computer program as claimed in claim 10, which when executed by the processor causes the processor to further perform, in a case where the judging result is impossible, electronically notify the user that it is impossible to ensure the communication quality.

12. A computer program as claimed In claim 11 wherein the ensuring request about the communication quality comprises a communication data rate request.

13. A method executed in a network access provider for providing a user with a connection that is between the user and a server designated by the user and that has a variable communication quality, comprising:
electronically receiving from the user a designation of a server and an ensuring request about a communication quality;
judging whether it is possible to establish a connection between the user and the server with the communication quality ensured;
if possible, starting to ensure the communication quality to provide the user with the connection with the communication quality;
detecting an end of the communication; and
charging on the user an access fee based on the communication quality and a time interval between the starting and the end of the communication.

14. A method as claimed in claim 13, wherein the ensuring request about the communication quality comprises a communication data rate request.

15. A method as claimed in claim 13, further comprising, after the judging, electronically notifying the user that it is impossible to ensure the communication quality if a result of the judging is “impossible.”

16. A method as claimed in claim 13, wherein the judging is carried out so that the starting to ensure the communication quality is carried out if network resources possessed by the network provider meet the communication quality in a case where the server designated by the user resides on a network owned by the network access provider.

17. A method as claimed in claim 13, wherein the judging is carried out so that the starting to ensure the communication quality is carried out if network resources possessed by an agreement provider of the network provider meet the communication quality in a case where the server designated by the user resides on a network owned by the agreement provider.

18. A variable communication quality network access provider implementing a method as claimed in claim 1, the provider comprising a core router, an access router connected to the core router and connectable by a user, and a fee-charging server connected to the access router, wherein:
the access router comprises:
means for electronically receiving from the user an ensuring request about a communication quality;
means for judging whether it is possible to ensure the communication quality, by communicating with the core router;
means for starting to ensure the communication quality if possible, so as to provide the user with an access with the communication quality and to report for the fee-charging server a start of a communication and the communication quality; and
means for detecting an end of the communication with the communication quality to report for the fee-charging server the end of the communication; and
the fee-charging server comprises:
means for electronically receiving the start of the communication and the communication quality from the access router;
means for electronically receiving the end of the communication from the access router; and
means for charging on the user an access fee based on the communication quality and a time interval between the start and the end of the communication.

19. A variable communication quality network access provider as claimed in claim 18, wherein the access router further comprises means for electronically notifying the user that it is impossible to ensure the communication quality if the judging result is “impossible.”

20. A variable communication quality network access provider as claimed in claim 18, wherein the ensuring request about the communication quality comprises a communication data rate request.
